(19) United States
(12) Patent Application Publication
(10) Pub. No.: US 2001/0030183 A1
(43) Pub. Date: Oct. 18, 2001

(54) Piece Press Micro Iron With Swiveling Handle And Interchangeable Sole Plates

(76) Inventor: Lorelle LaBarge Bowen, Panama City, FL (US)

Correspondence Address: SMITH & HOPEN PA, 15950 BAY VISTA DRIVE, SUITE 220, CLEARWATER, FL, 33760

(21) Appl. No.: 09/548,408

(22) Filed: Apr. 13, 2000

(51) Int. Cl. H05B 3/00; D06F 75/00

(52) U.S. Cl. 219/246; 219/249; 219/245; 219/227; 38/81; 38/82; 101/31

(57) ABSTRACT

A heating iron apparatus including an elongate handle with a front end and rear end, a heating element secured to the front end of the elongate handle and powered by a voltage means, and a sole plate engaging means adapted to secure a heat conductive sole plate, the heat conductive sole plate abutting the heating element and translating heat from the heating element to a contact surface wherein the contact surface is pressed against a fabric surface. A temperature control switch in galvanic communication with the voltage means may be incorporated into the apparatus wherein the temperature of the heating element is regulated by the temperature control switch.

### RELATED APPLICATIONS

This application is related to, and claims domestic priority benefits from, U.S. Provisional patent application Ser. No. 60/129,185 filed on Apr. 14, 1999, the entire content of which is expressly incorporated hereinto by reference.

### FIELD OF INVENTION

The present invention relates generally to an apparatus for ironing fabrics, and more particularly to an adjustable precision ironing device with quick-change ironing plates.

### BACKGROUND OF THE INVENTION

This invention is direct to a novel precision ironing device that permits users to quickly and easily exchange decorative and non-decorative sole plates during the ironing process.

An object of this invention is to provide an iron which can easily exchange multiple sole plates without cumbersome fastening means.

Another object of this invention is to provide an iron which is adjustable for users which may wish to either hold the device vertically as a writing instrument, or hold the device horizontally as is traditionally done for irons.

Another object of the invention is to provide an iron which does not require a support cradle for keeping the heated sole plate away from a work surface.

Another object of the invention is to provide a sole plate cavity apparatus to engage and disengage a plurality of sole plates from the iron with reduced manual manipulation.

Previous attempts have been made to provide similar devices such as described in U.S. Pat. No. 4,546,560 to Granata ('560 patent) which is incorporate herein by reference. The '560 patent describes a seam pressing having an elongate handle and a heating element conducting heat to a sole plate. However, the '560 patent does not anticipate, teach or suggest an iron having an easily changeable sole plate, nor does it describe any means for securely maintaining different angles with respect to the sole plate and the elongate handle.

Consequently, there is a need in the art for an iron apparatus able to quickly and easily exchange different sole plates.

There is a further need in the art for an iron that can rigidly or swingably adjust its handle from a vertical to horizontal position.

However, in view of the prior art in at the time the present invention was made, it was not obvious to those of ordinary skill in the pertinent art how the identified needs could be fulfilled.

### SUMMARY OF THE INVENTION

Generally described, the present invention provides a heating iron apparatus comprising an elongate handle with a front end and rear end, a heating element secured to the front end of the elongate handle and powered by a voltage means, and a sole plate engaging means adapted to secure a heat conductive sole plate, the heat conductive sole plate abutting the heating element and translating heat from the heating element to a contact surface wherein the contact surface is pressed against a fabric surface.

A temperature control switch in galvanic communication with the voltage means may be incorporated into the apparatus wherein the temperature of the heating element is regulated by the temperature control switch. In addition, a light emitting diode (LED) may be incorporated into the elongate handle to indicate whether the power is on, or alternatively, whether the contact surface is above a threshold temperature for safety purposes.

In a preferred embodiment of the invention, particularly for applications that do not require the temperature of the heating element to exceed 770° C. the sole plate engaging means comprises a ferromagnetic coupling of the heating element and the heat conductive sole plate. This coupling foregoes the need for mechanical clips, screws or other fasteners.

In an alternative embodiment, the sole plate engaging means comprises a plate slot wherein the heat conductive sole plate is slideably received within the plate slot and retained by an interference fit. More specifically, a substantially horizontal flange surrounding said heating element is slideably received by a heat conductive sole plate having a lower contact surface and an upper locking clip interface thereby causing said heat conductive sole plate to abut said heating element and translate heat from said heating element to said contact surface.

A notorious problem with any iron is the risk that it will burn fabrics and support surfaces while not in use. Typically in the case of small, precision irons, a holding stand is provided. Another problem that exists for precision irons is the lack of adjustability. Users might have conditions such as arthritis which requires control of the iron in different orientations. However, an embodiment of the current invention overcomes this problem by providing a lockable swivel hinge engaged between the elongate handle and the heating element wherein the elongate handle may be adjusted between a substantially horizontal orientation while in use to a substantially vertical orientation. In an unlocked state, the elongate handle and sole plate can swivel freely to the movement of the user. In a locked state, the elongate handle and sole plate are in a fixed position. Such a state might be desired for more precise control over the apparatus.

A support member extending in substantially downward perpendicular alignment from the front end of the elongate handle may also be provided wherein the swivel hinge may be adjusted to permit the heating iron apparatus to be rested horizontally on a planer surface without the contact surface touching the planer surface.

Small, precision irons have a number of applications which include more than just smoothing the creases of a fabric. The irons may be used to join multiple pieces of fabric together with heat-sensitive adhesive or to impress decorative patterns on impressionable fabric types such as velvet. Plastic may be melted for model makers. Glue gun errors may be corrected. Leather crafters may “brand” goods with a specific design or logo. A raised pattern on the contact surface of a preselected geometric design may be provided wherein the preselected,geometric design is translated by compression and heat to the fabric surface. A unique pattern may be provided on each individual sole plate. This system takes advantage of the quick change capability of the current invention wherein sophisticated, multi-pattern designed may be easily impressed into a fabric by the user.

In order to facilitate multi-pattern designs, a storage means may be provided having a plurality of sole plate cavities each adapted to receive a corresponding heat conductive sole plate and an engaging means for releasing and retaining the corresponding heat conducting sole plate in each of the plurality of sole plate cavities. In one embodiment, the storage means is constructed of a ferromagnetic substance wherein the corresponding heat, conductive sole plate is magnetically engaged within a corresponding sole plate cavity. In an alternative embodiment, the ferromagnetic substance is electro-magnetically activated to increase the attractive pull of the corresponding heat conductive sole plate into the corresponding sole plate cavity. In order to permit the exchange of sole plates during the iron process the plurality of sole plate cavities are constructed of substantially heat resistant material and preferably of ceramic material.

Accordingly, an object of this invention is to provide an iron which can easily exchange multiple sole plates without cumbersome fastening means.

Another object of this invention is to provide an iron which is adjustable for users which may wish to either hold the device vertically as a writing instrument, or hold the device horizontally as is traditionally done for irons.

Another object of the invention is to provide an iron which does not require a support cradle for keeping the heated sole plate away from a work surface.

Another object of the invention is to provide a sole plate cavity apparatus to engage and disengage a plurality of sole plates from the iron with reduced manual manipulation.

An advantage of the invention is that multiple sole plates, either of differing sizes or of differing decorative designs may be easily installed in the iron without cumbersome mechanical fasteners.

Another advantage of the invention is that the elongate handle of the iron may be adjusted to a substantially vertical or horizontal position while in use. The hinge may be allowed to freely swivel during use or may be locked at a predetermined angle for more precise control.

Another advantage of the invention is that the hinge may be utilized to swing the sole plate out of contact with a work surface while the iron is resting on the work surface. This forgoes the need for a cradle support device to prevent heat damage to the work surface.

These and other important objects, advantages, and features of the invention will become clear as this description proceeds.

The invention accordingly comprises the features of construction, combination of elements, and arrangement of parts that will be exemplified in the description set forth hereinafter and the scope of the invention will be indicated in the claims.

### BRIEF DESCRIPTION OF THE DRAWINGS

For a fuller understanding of the nature and objects of the invention, reference should be made to the following detailed description, taken in connection with the accompanying drawings, in which:

FIG. 1 is a partially sectional, side elevational view of the invention.

FIG. 2 is a partially exploded, side elevational view of the invention showing the insertion of a sole plate into a sole plate engaging means.

FIG. 3 is a side elevational view of the invention wherein the elongate handle is swiveled to a substantially vertical position.

FIG. 4 is a front elevational view of the invention.

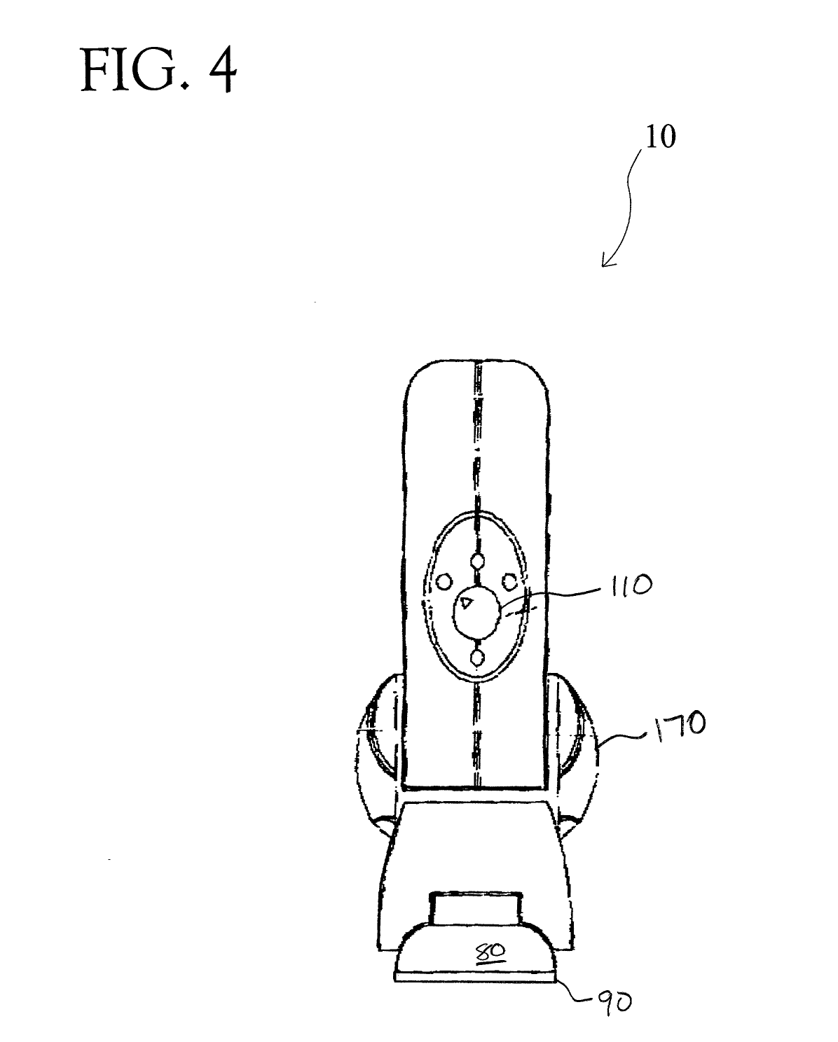

FIG. 5 is a partially exploded, side elevational view of the invention showing the insertion of a sole plate by magnetic coupling into a sole plate engaging means.

FIG. 6 is a side elevational view of the invention resting on a work surface wherein the sole plate is swiveled up to prevent it from coming into contact with said work surface.

FIG. 7 is an isometric view of a sole plate storage container also showing preselected geometric designs on sole plates contained therein.

FIG. 8 is an isometric view of a second embodiment of the sole plate storage container showing an electromagnetic base.

### DETAILED DESCRIPTION OF THE PREFERRED EMBODIMENT

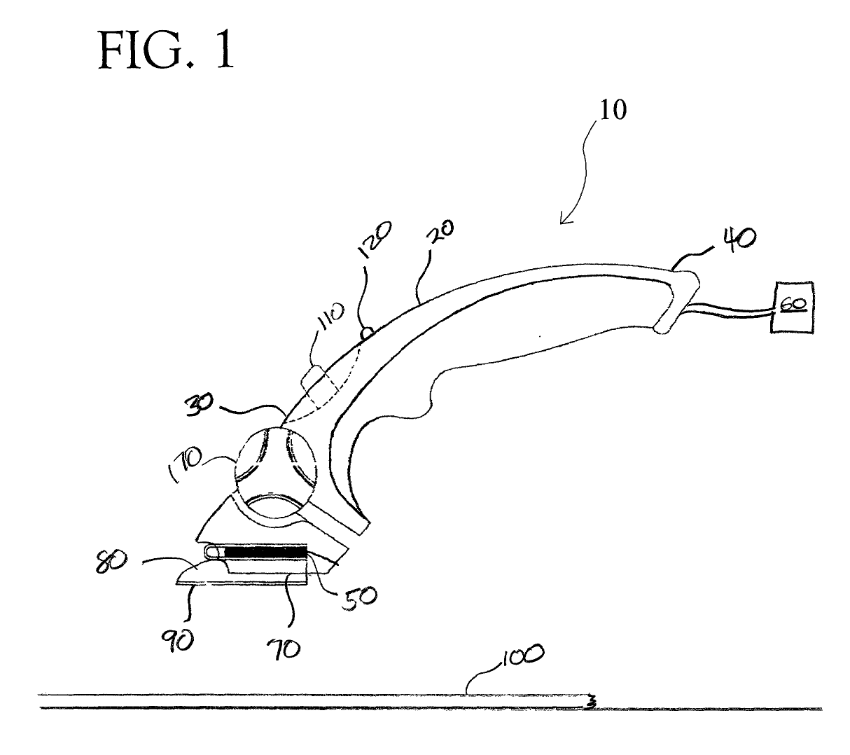

Referring initially to FIG. 1, it will there be seen that an illustrative embodiment of the present invention is denoted by the reference number 10 as a whole. A heating iron apparatus comprising an elongate handle 20 with a front end 30 and rear end 40, a heating element 50 secured to the front end of the elongate handle 20 and powered by a voltage means 60, and a sole plate engaging means 70 adapted to secure a heat conductive sole plate 80, the heat conductive sole plate 80 abutting the heating element 50 and translating heat from the heating element 50 to a contact surface 90 wherein the contact surface 90 is pressed against a fabric surface 100.

A temperature control switch 110 in galvanic communication with the voltage means 60 may be incorporated into the apparatus wherein the temperature of the heating element 50 is regulated by the temperature control switch 110. In addition, a light emitting diode (LED) 120 may be incorporated into the elongate handle 20 to indicate whether the power is on, or alternatively, whether the contact surface 90 is above a threshold temperature for safety purposes.

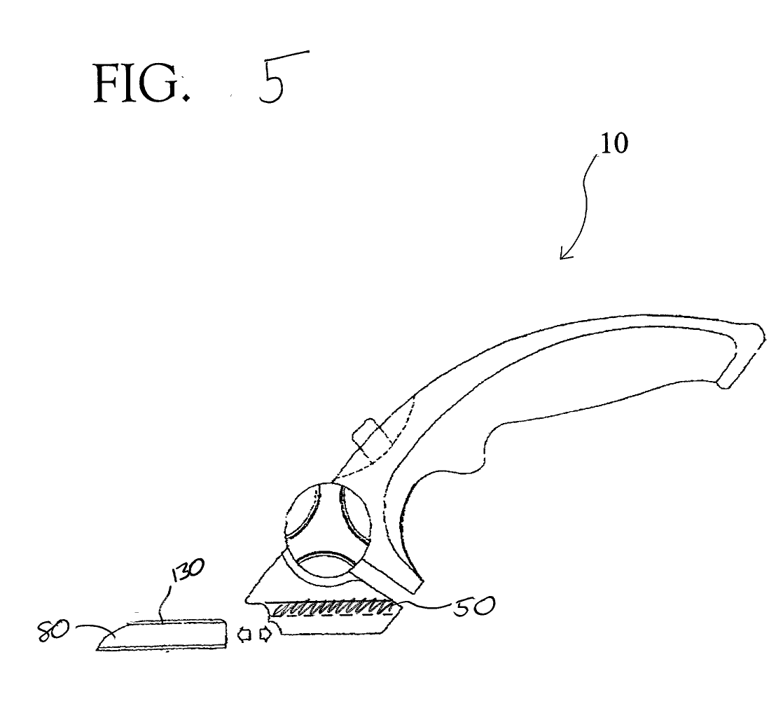

FIG. 5 illustrates a ferromagnetic coupling 130 of the heating element 50 and the heat conductive sole plate 80. In this embodiment of the invention the temperature of the heating element should not exceed 770° C. (i.e., the Curie temperature upon which ferromagnetic materials lose their magnetic properties). In the illustration, the ferromagnetic coupling 130 is showed to be on the upper side of the heat conductive sole plate 80. However, the ferromagnetic coupling may also be rigidly secured or incorporated into the sole plate engaging means 70 or the heating element 50 itself. An electromagnetic attachment of the heat conductive sole plate 80 to the heating element 50 may also be achieved, by energizing an electromagnetic to draw the heat conductive sole plate 80 in abutting relationship with the heating element 50.

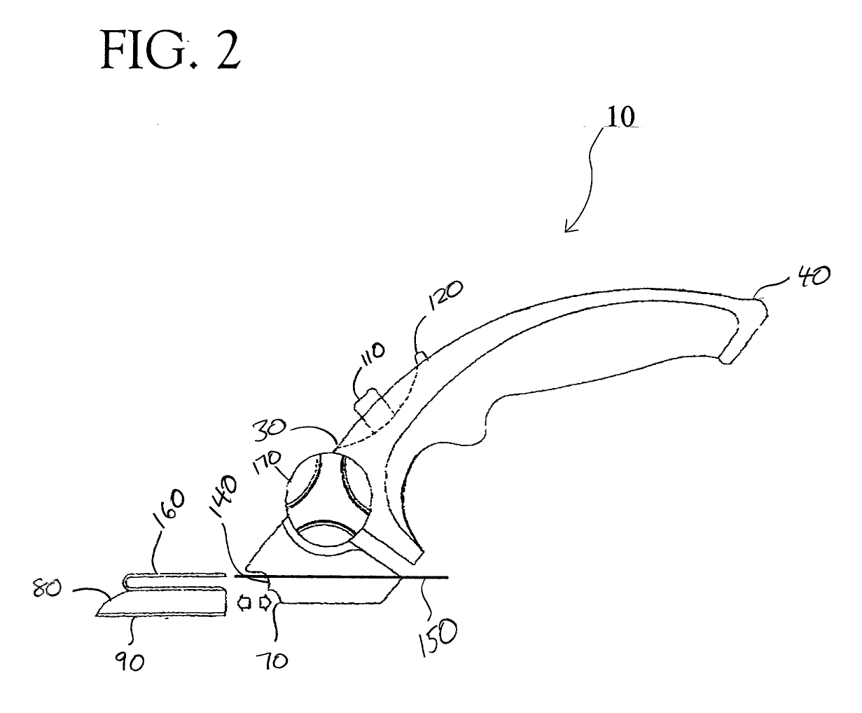

In an alternative embodiment as illustrated by FIG. 2, the sole plate engaging means comprises a plate slot 140 wherein the heat conductive sole plate 80 is slideably received within the plate slot 140 and retained by an interference fit. More specifically, a substantially horizontal flange 150 surrounding said heating element is slideably received by a heat conductive sole plate 80 having a lower contact surface 90 and an upper locking clip interface 160 thereby causing said heat conductive sole plate 80 to abut said heating element 50 and translate heat from said heating element 50 to said contact surface 90.

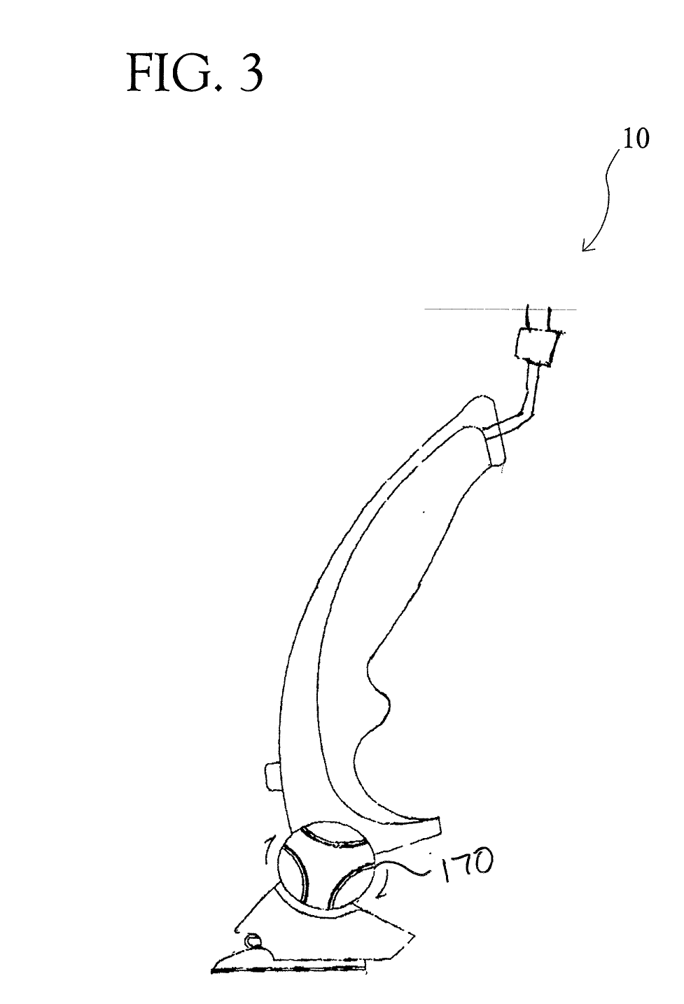

FIG. 3 illustrates an embodiment of the invention providing a lockable swivel hinge 170 engaged between the elongate handle 20 and the heating element 50 wherein the elongate handle 20 may be adjusted between a substantially horizontal orientation while in use to a substantially vertical orientation. In an unlocked state, the elongate handle 20 and sole plate 80 can swivel freely to the movement of the user. In a locked state, the elongate handle 20 sole plate 80 are in a fixed position. Such a state might be desired for more precise control over the apparatus.

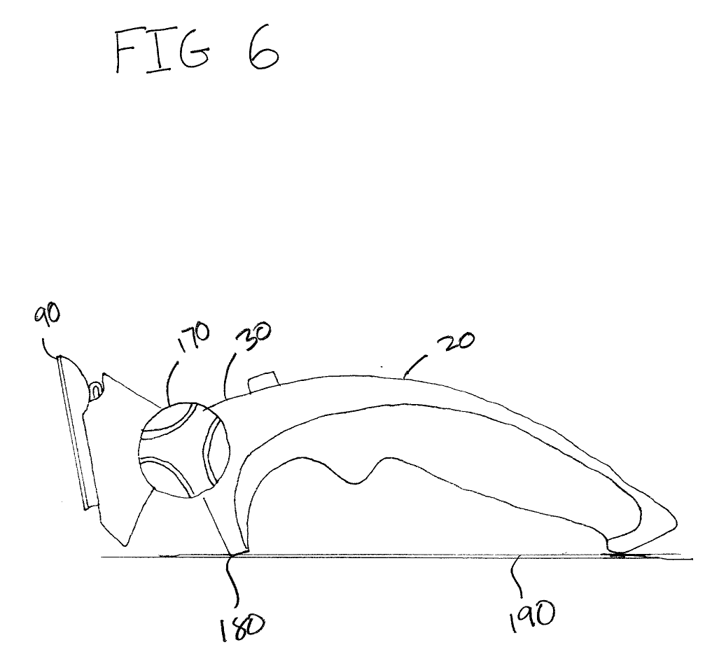

In FIG. 6 a support member 180 extending in substantially downward perpendicular alignment from the front end 30 of the elongate handle 20 may also be provided wherein the swivel hinge 170 may be adjusted to permit the heating iron apparatus to be rested horizontally on a planer surface 190 without the contact surface 90 touching the planer surface 190.

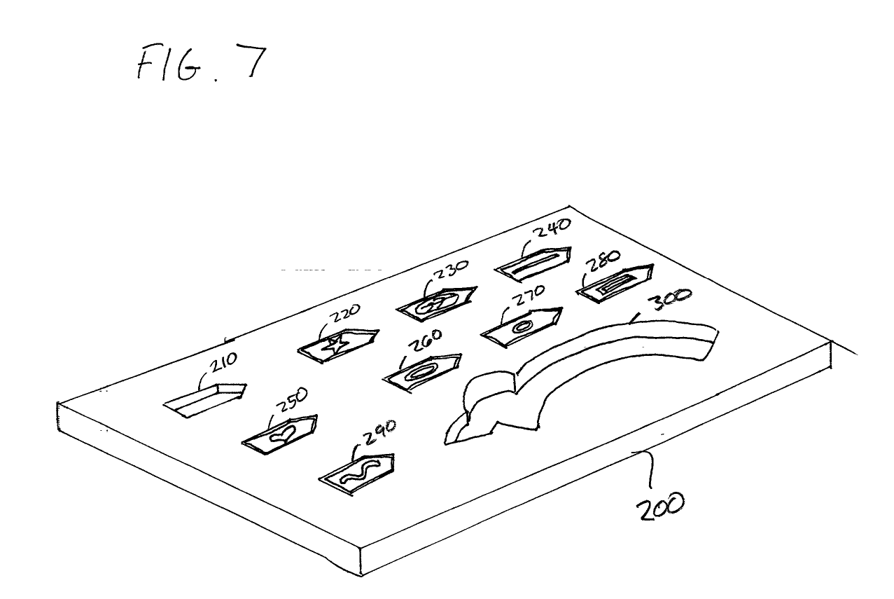

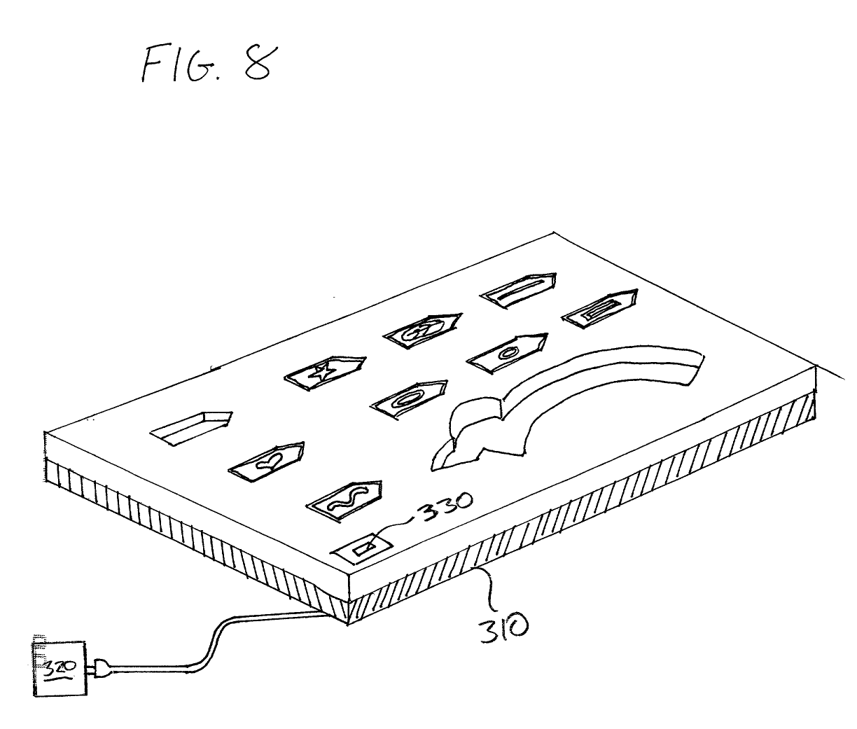

FIG. 7 illustrates unique patterns which may be provided on each individual sole plate. In order to facilitate multi-pattern designs, a storage means 200 may be provided having a plurality of sole plate cavities 210-290 each adapted to receive a corresponding heat conductive sole plate and an engaging means for releasing and retaining the corresponding heat conducting sole plate 80 in each of the plurality of sole plate cavities 210-290. In one embodiment, the storage means 200 is constructed of a ferromagnetic substance wherein the corresponding heat conductive sole plate 80 is magnetically engaged within a corresponding sole plate cavity. In an alternative embodiment illustrated in FIG. 8, the ferromagnetic substance is electro-magnetically activated to increase the attractive pull of the corresponding heat conductive sole plate 80 into the corresponding sole plate cavity 210-290. An electromagnetic plate 310 is disposed below the storage means 200 and is in galvanic communication with a power source 320. A switching means energizes the electromagnetic plate 310 to attract the heat conductive sole plates 80 into their corresponding sole plate cavity 210-290. In order to permit the exchange of sole plates during the iron process the plurality of sole plate cavities are constructed of substantially heat resistant material and preferably of ceramic material.

It will be seen that the objects set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween. Now that the invention has been described,

What is claimed is:

1. A heating iron apparatus comprising:
an elongate handle with a front end and rear end;
a heating element secured to said front end of said elongate handle and powered by a voltage means; and
a sole plate engaging means adapted to secure a heat conductive sole plate, said heat conductive sole plate abutting said heating element and translating heat from said heating element to a contact surface wherein said contact surface is pressed against a fabric surface.

2. The heating iron apparatus of claim 1 further comprising a temperature control switch in galvanic communication with said voltage means wherein the temperature of said heating element is regulated by said temperature control switch.

3. The heating iron apparatus of claim 1 wherein said sole plate engaging means comprises a ferromagnetic coupling of said heating element and said heat conductive sole plate.

4. The heating iron apparatus of claim 1 wherein said sole plate engaging means comprises a plate slot wherein said heat conductive sole plate is slideably received within said plate slot and retained by an interference fit.

5. The heating iron apparatus of claim 1 further comprising a swivel hinge engaged between said elongate handle and said heating element wherein said elongate handle may be adjusted between a substantially horizontal orientation while in use to a substantially vertical orientation.

6. The heating iron apparatus of claim 5 further comprising a support member extending in substantially downward perpendicular alignment from said front end of said elongate handle wherein said swivel hinge may be adjusted to permit said heating iron apparatus to be rested horizontally on a planer surface without said contact surface touching said planer surface.

7. The heating iron apparatus of claim 1 further comprising a raised pattern on said contact surface of a preselected geometric design wherein said preselected geometric design is translated by compression and heat to said fabric surface.

8. The heating iron apparatus of claim 1 further comprising:
a storage means having a plurality of sole plate cavities each adapted to receive a corresponding heat conductive sole plate; and an engaging means for releasing and retaining said corresponding heat conducting sole plate in each of said plurality of sole plate cavities.

9. The heating iron apparatus of claim 8 wherein said storage means is constructed of a ferromagnetic substance wherein said corresponding heat conductive sole plate is magnetically engaged within a corresponding sole plate cavity.

10. The heating iron apparatus of claim 9 wherein said ferromagnetic substance is electro magnetically activated to increase the attractive pull of said corresponding heat conductive sole plate into said corresponding sole plate cavity.

11. The heating iron apparatus of claim 8 where said plurality of sole plate cavities are constructed of substantially heat resistant material.

12. The heating iron apparatus of claim 11 wherein said plurality of sole plate cavities are constructed of ceramic material.

13. A heating iron apparatus comprising:
an elongate handle with a front end and rear end;
a heating element secured to said front end of said elongate handle and powered by a voltage means;
a temperature control switch in galvanic communication with said voltage means wherein the temperature of said heating element is regulated by said temperature control switch;
a swivel hinge engaged between said elongate handle and said heating element wherein said elongate handle may be adjusted between a substantially horizontal orientation while in use to a substantially vertical orientation;
a support member extending in substantially downward perpendicular alignment from said front end of said elongate handle wherein said swivel hinge may be adjusted to permit said heating iron apparatus to be rested horizontally on a planer surface without said contact surface touching said planer surface;
a substantially horizontal flange surrounding said heating element; a heat conductive sole plate having a lower contact surface and an upper locking clip interface which slideably receives said substantially horizontal flange thereby causing said heat conductive sole plate to abut said heating element and translate heat from said heating element to said contact surface; and
a raised pattern on said contact surface of a preselected geometric design wherein said preselected geometric design is translated by compression and heat to said fabric surface.
